(19) United States
(12) Patent Application Publication
(10) Pub. No.: US 2009/0276135 A1
(43) Pub. Date: Nov. 5, 2009

(54) Adaptive cruise controller having dynamics matching as a function of the situation

(76) Inventors: Markus Hagemann, Stuttgart (DE); Oliver Schwindt, Rutesheim (DE)

Correspondence Address: KENYON & KENYON LLP, ONE BROADWAY, NEW YORK, NY, 10004, US

(21) Appl. No.: 11/921,267

(22) PCT Filed: Apr. 27, 2006
(86) PCT No.: PCT/EP2006/061863

§ 371 Date: Jul. 9, 2009

(30) Foreign Application Priority Data
Jun. 7, 2005 (DE) 10 2005 026 065.9

(51) Int. Cl. B60W 30/16

(52) U.S. Cl. 701/96; 701/93

(57) ABSTRACT

An adaptive cruise controller having dynamics matching as a function of the situation includes an identification device for identifying various predefined categories of single-file driving situations, and for selecting a dynamic profile matched to the situation identified.

### BACKGROUND INFORMATION

For motor vehicles, adaptive cruise controllers are known which allow not only automatic control of the driving speed to a desired speed selected by the driver, but also automatic speed adjustment and distance control in cases when a slower preceding vehicle is in the lane of the host vehicle and is located, for example, with the aid of a radar system. Based on the distance and relative-velocity data supplied by the radar system, the controller calculates a positive or negative setpoint acceleration, which is then implemented by a corresponding intervention in the drive system and, if necessary, also the brake system of the vehicle, so that the preceding vehicle is followed at a suitable safety distance. As a rule, this safety distance is time-dependent, and is defined by the so-called time gap, i.e., the time interval between the preceding vehicle and the host vehicle.

In view of the most comfortable and fuel-saving driving style possible, the setpoint accelerations allowed during the operation of the cruise controller are limited to a predefined acceleration range. The upper limit of this acceleration range and the time gap are examples for parameters which determine the dynamic profile of the cruise controller. In the case of high dynamics, higher accelerations are allowed, and the setpoint time gap is set to a relatively low value.

The parameters which determine the dynamic profile are either predefined in a fixed manner in the system, or are adjustable by the driver as desired. For example, ACC systems are known in which the driver is able to select the setpoint time gap in a range between 1 and 2 seconds according to his/her personal preference. In the same way, systems are known in which the driver is able to select between predefined dynamic profiles (e.g., “sporty” or “fuel-saving”), each of which is determined by a special set of parameters. In some systems, the dynamic profile may also be matched to the preferences of the specific driver based on an automatic driver recognition.

German Patent Application No. DE 198 43 395 describes an adaptive cruise controller in which an automatic matching of the dynamic profile to the specific traffic situation is also provided. For example, distinction is made here between the following traffic situations: normal driving on freeways, passing on freeways, normal driving on highways, passing on highways, normal driving in city traffic, passing in city traffic and stop and go. Moreover, this publication also mentions the possibility of accessing data of a navigation system, so that, for example, prior to a curvy route section, it is possible to switch automatically to lower dynamics.

The ACC systems in use till now are generally provided for driving on expressways or well-enlarged highways and can only be used above a specific threshold speed of, e.g., 30 km/h. However, advanced systems are in development which are also usable at lower speeds up to the vehicle standstill and which, for instance, in stop and go traffic also permit automatic braking of the vehicle to a standstill and, under certain conditions, automatic driving off of the vehicle again, as well. Such systems are known as “full-speed range ACC” (ACC-FSR) or “ACC/stop & go.”

### SUMMARY OF THE INVENTION

Especially in such advanced ACC systems, the present invention makes it possible to improve the traffic flow and allows a driving style complying better with the intuitive behavior of a human driver. For that purpose, the cruise controller has an identification device which is designed especially to identify various predefined categories of single-file driving situations, and to match the dynamic profile to the situation identified in each case.

In general, to be understood here by the term “single-file driving situation” is a situation in which several vehicles are traveling or standing one behind the other in the same lane, the host vehicle equipped with the ACC system being one of the vehicles in this line. A typical example for such a single-file driving situation is, for instance, a traffic jam on an expressway. Another example is waiting in a line at a traffic light in city traffic. At the same time, these two examples represent examples for two different categories of single-file driving situations, where in each case a different dynamic profile should be used.

In the case of a traffic jam or in slow-moving traffic, a profile having low dynamics, thus, in particular with low maximum acceleration and large time gap, is advisable. Namely, high dynamics, thus rapid drive-up and relatively close pull-up to the preceding vehicle, especially in the case of longer lines of traffic and above all when a majority of drivers in the line behave in this way, leads easily here to a so-called “accordion effect,” i.e., phases in which the vehicles are relatively far apart, alternating with phases in which the vehicles pull up closely and must be braked relatively sharply, resulting easily in rear-end collisions. In such situations, frequently a wave of congestion develops which spreads out facing rearward and, because of the delayed reactions of the vehicles involved, constantly increases until traffic comes to a complete standstill. This is the typical scenario for an overload of traffic congestion on expressways. A profile with lower dynamics acts here as a counterbalance, and thus helps to improve the traffic flow. It also more likely corresponds to the intuitive behavior of more experienced human drivers. In addition, fuel consumption is reduced by a profile having lower dynamics.

On the other hand, when driving off from a line of traffic waiting at a traffic signal or intersection, a more dynamic profile is more likely appropriate. Namely, here a speedy drive-off and closer pull-up to the preceding vehicle—within the limits of traffic safety—permits a greater number of vehicles to cross the intersection during a green phase, so that a substantially greater volume of traffic can be handled without a traffic jam occurring.

Using the present invention, in each case the appropriate dynamic profile is selected automatically in these various situations, so that the system performance corresponds better to the intuition and expectations of a human driver. In this way, the present invention increases the acceptance of the ACC system, and at the same time helps to improve the traffic flow.

Preferably, the identification device of the cruise controller has an interface to a navigation system, so that based on the information about the road network available in the navigation system and the position of the host vehicle, it is possible to determine whether the host vehicle is on a road without intersections or, for instance, is before an intersection. In this way, the single-file driving situation may in each instance be assigned to the correct category.

Alternatively or additionally, however, it is also possible to access other information sources, e.g., a video and image processing system, for recognizing intersections and the like.

In addition, to recognize traffic-jam situations early on, it is also possible to access the data of a traffic-congestion information system, for instance, congestion information in traffic announcements, via the mobile radio network or, possibly in the future, also via an intelligent navigation system, as well as, provided a video system having image processing is available, by the detection of traffic-congestion warnings on dynamic traffic-signal systems.

### BRIEF DESCRIPTION OF THE DRAWINGS

FIG. 1 shows a block diagram of an adaptive cruise controller.

FIGS. 2 and 3 show sketches of different traffic situations for clarifying the method of operation of the cruise controller.

### DETAILED DESCRIPTION

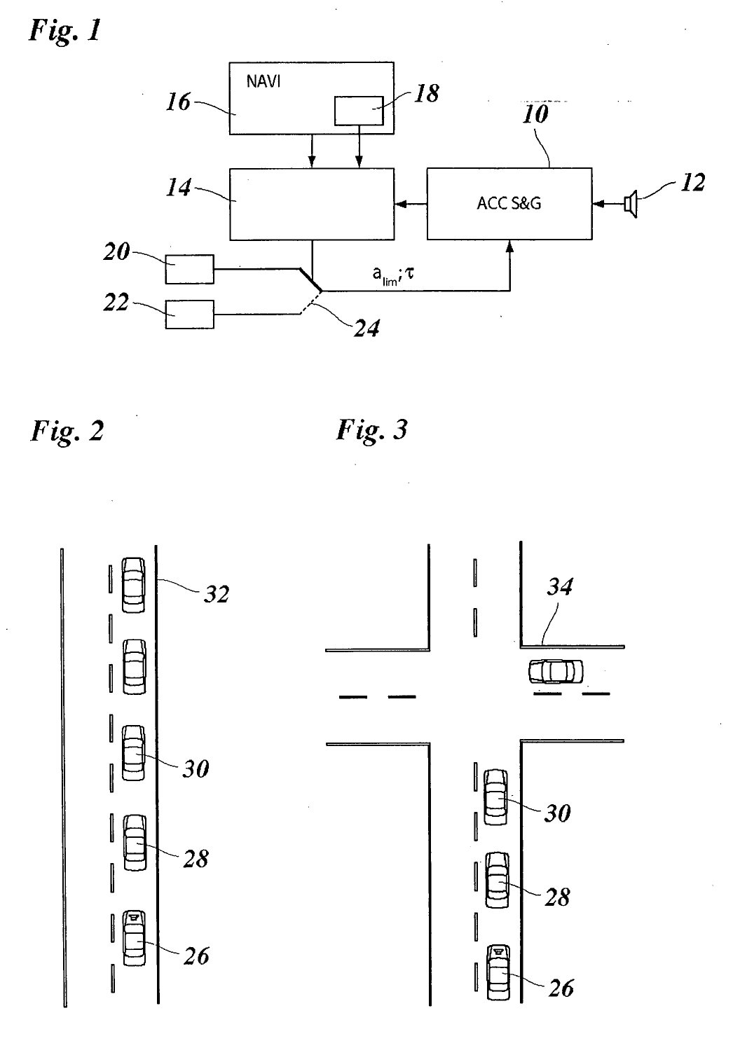

The principal item of the cruise controller shown in FIG. 1 is an electronic controller unit 10, known per se, having ACC and stop & go functions, which receives locating data about preceding vehicles from a radar sensor 12 having angular resolution, and evaluates it in order to control the driving speed by intervention in the vehicle drive system and brake system (not shown). Vehicles in adjacent lanes can also be located with the aid of radar sensor 12 and, because of the angular-resolution capability, the located vehicles may be assigned to the individual traffic lanes. At least in the case of higher traffic density, the statistical evaluation of this data also makes it possible to determine the lane in which the host vehicle is located.

Controller unit 10 is assigned an identification device 14 which is used to identify various traffic situations, among which in particular are also single-file driving situations. In the case of single-file driving situations, various predefined categories are differentiated, e.g., “traffic-jam situation without intersection” and “line of traffic waiting at an intersection,” and the situation identified in each case is assigned by identification device 14 to one of these predefined categories. For this purpose, identification device 14 accesses the data of controller unit 10, including prepared locating data of radar sensor 12. Furthermore, identification device 14 has an interface 16 to a navigation system available in the vehicle, as well as an interface 18 to a traffic-congestion information system, e.g., a traffic-announcement system that here is integrated into the navigation system. Based on the data received via these interfaces, identification device 14 is able to identify, for instance, whether the vehicle is in a reported traffic jam or whether such a traffic jam is imminent, whether the vehicle is located before an intersection or a freeway entrance, and the like. In the case of an intelligent navigation system that receives constantly updated data about the traffic infrastructure, construction sites may also be identified, if need be.

Also belonging to identification device 14 is a memory in which at least one dynamic profile 20, 22 is stored for each predefined category of single-file driving situations. Alternatively, several dynamic profiles which take into account the personal preferences of the respective driver may also be stored for a single category. In the example considered here, only two dynamic profiles 20, 22 are shown, namely, one for a traffic-jam situation without intersection (FIG. 2) and one for a line of traffic waiting before an intersection (FIG. 3).

Each dynamic profile is defined by a set of parameters which determine the functioning method of controller unit 10 in the respective situation category. Examples for such parameters are maximum acceleration aₗᵢₘ, which is the maximum acceleration with which the vehicle is accelerated when driving up to a preceding vehicle that is itself accelerating, or when the lane in front of the host vehicle has become free, as well as time gap τ with which the preceding vehicle is followed when driving behind a vehicle and the distance control is active.

In a recognized single-file driving situation, identification device 14 selects one of the dynamic profiles 20, 22 depending upon the category recognized, so that corresponding parameters aₗᵢₘ, τ are fed into controller unit 10, as symbolized by a switch 24 in FIG. 1. If the situation recognized is not a single-file driving situation, switch 24 is also able to assume a neutral position, so that controller unit 10 then operates using a standard dynamic profile.

Optionally, dynamic profiles 20, 22 may also be defined by only one parameter, or by more than two parameters, or by more complex variables. For example, using an additional parameter, it is possible to define a dip-in strategy for the case when the host vehicle temporarily drops below time gap τ, thus dips a little into the safety distance to the preceding vehicle when the preceding vehicle becomes slower. Such a dip-in strategy makes it possible to avoid uncomfortably great deceleration of the host vehicle and to compensate for unevenness in the driving style of the preceding vehicle.

Instead of parameter aₗᵢₘ, a function may also be defined which preselects a specific acceleration value or a specific acceleration pattern for each difference between the actual speed and the setpoint speed of the host vehicle.

Optionally, an additional parameter of the dynamic profile may determine a temporary increase in the desired speed selected by the driver. So, for instance, in the case of great traffic density, during a passing maneuver it may be determined to temporarily increase the desired speed to a value that, for example, is 5 km/h above the absolute speed of the overtaken vehicle, so that the passing maneuver is shortened.

The traffic situation shown in FIG. 2 corresponds to driving single-file in a traffic jam or in slow-moving traffic on a road without intersections. Vehicle 26 equipped with the cruise controller according to FIG. 1 is one of the vehicles in the line. At least vehicle 28 directly preceding is located with the aid of radar sensor 12. Generally, however, vehicles 30 traveling further in front are also not completely blocked by vehicle 28, so that they can likewise be located. In this way, identification device 14 is able to identify a single-file driving situation even when there is no report of a traffic jam. In principle, the fact that directly preceding vehicle 28 has been traveling for a longer period of time with a speed that is markedly below the desired speed set is already sufficient for identifying a single-file driving situation.

In addition, based on the data of the navigation system, it may be determined that host vehicle 26 is on intersection-free road 32, or at least on an intersection-free section of the road. In this case, identification device 14 selects dynamic profile 20, which is characterized by relatively low dynamics. Accordingly, aₗᵢₘ has a relatively small value, while time gap τ is relatively large. Therefore, if preceding vehicles 28, 30 accelerate, host vehicle 26 will follow them with only a moderate acceleration. Since in the case of slow-moving traffic, for the most part such an acceleration phase is followed again after a short time by a deceleration phase, a more comfortable, relaxed and fuel-saving driving style is thus achieved for host vehicle 26, and at the same time, the oscillations in traffic flow are smoothed out. Enlarged time gap τ provides for a large safety distance to the preceding vehicle, thereby reducing the danger of rear-end collisions, and at the same time creating room for a dip-in strategy by which it is possible to compensate even better for the fluctuations in traffic flow.

FIG. 3 illustrates a single-file driving situation in which host vehicle 26 and remaining vehicles 28, 30 are in a line waiting at an intersection 34. The presence of the intersection is recognized based on the data transmitted from the navigation system via interface 16. In this situation, for a certain time span corresponding approximately to the duration of time for the line to drive off, identification device 14 causes a switchover to dynamic profile 22 that is characterized by high dynamics. In this case, higher accelerations are allowed and the time gap is shortened, so that host vehicle 26 pulls up faster and closer to preceding vehicle 28 when the line moves again. In this way, a greater number of vehicles is able to pass through intersection 34 in a predefined time, thereby improving the traffic flow. This behavior also corresponds to the expectations and the natural driving style of a human driver, who likewise will pull up close to the preceding vehicle in this situation.

In the situation shown in FIG. 3, the category “line of traffic waiting at an intersection” can also be recognized, at least given high traffic density, when host vehicle 26 is the first vehicle in the line and is stopped directly before intersection 34. It may be that the following vehicles cannot then be located directly, however generally their presence can be assumed. A measure for the traffic density may be obtained by statistical evaluation of the locating data of radar sensor 12. In the case of low traffic density, e.g., nights, when it may thus be assumed that host vehicle 26 alone is stopped before intersection 34, instead of dynamic profile 22, the standard profile may therefore be selected, so that the host vehicle accelerates more slowly when the driver gives the command to drive off. Last but not least, the disturbance caused by noise for the residents living nearby is thereby also reduced.

The categories of single-file driving situations described above may still be refined and expanded considerably. For example, in the traffic-congestion situation according to FIG. 2, when host vehicle 26 and preceding vehicles 28, 30 are in the left lane, and vehicles in both lanes are traveling with approximately the same speed as is often the case in traffic congestion, a dynamic profile may be selected in which τ is decreased compared to dynamic profile 20, so that vehicles from the right lane are prevented from cutting into the safety distance.

A further conceivable refinement is that in traffic-jam situations on roads without intersection, to distinguish between driving in the traffic jam and driving into the back end of the traffic jam on one hand, and the breakup of the traffic jam on the other hand, e.g., based on the data of the traffic-congestion information system. One criterion for the category “breakup of the traffic jam” may also be that the preceding vehicles in the left lane are accelerating and the right lane is free. In this situation, it is expedient to switch to a profile with higher dynamics, so that the breakup of the traffic jam is accelerated.

Further conceivable categories which can be identified based on the data of the radar sensor and/or the data of an intelligent navigation system are narrowing of the roadway from two lanes to one lane, for instance, at construction sites, as well as widening of the roadway from one lane to two lanes. In this case, before a roadway narrowing, a profile with low dynamics and with particularly large time gap τ is selected, thereby making it easier for vehicles to slip in according to the traffic zipper principle. Upon leaving the construction site, there is then a switchover to a profile with higher dynamics, so that the traffic flow is improved.

In the same way, it is conceivable to increase time gap τ in the area of freeway accesses, thereby facilitating lane changes for vehicles entering or turning off.

According to one variant, when driving in the right lane in the area of freeway entrances, time gap τ is only increased if, in the acceleration lane, a vehicle is located whose distance is greater than a specific minimum distance. On the other hand, if the distance of the vehicle in the acceleration lane is less than a specific lower limiting value, the time gap may, on the contrary, be shortened and the acceleration increased in order to make it easier for the entering vehicle to slip in behind the host vehicle.

1-6. (canceled)

7. An adaptive cruise controller having dynamics matching as a function of the situation, comprising:
an identification device for identifying various predefined categories of single-file driving situations, and for selecting one dynamic profile matched to the situation identified.

8. The cruise controller according to claim 7, wherein in identifying the categories, the identification device distinguishes whether a host vehicle is on a road without intersections, or on a road section before an intersection or junction.

9. The cruise controller according to claim 7, wherein the identification device includes an interface to a navigation system.

10. The cruise controller according to claim 7, wherein the identification device includes an interface to a traffic-congestion information system.

11. The cruise controller according to claim 7, wherein dynamic profiles differ in a parameter which determines an acceleration behavior of a host vehicle in response to changes in speed of preceding vehicles, or when a traffic lane traveled by the host vehicle becomes free.

12. The cruise controller according to claim 7, wherein dynamic profiles differ in a time gap with which a preceding vehicle is followed within the framework of a distance control.
